(19) United States
(12) Patent Application Publication
(10) Pub. No.: US 2023/0008137 A1
(43) Pub. Date: Jan. 12, 2023

(54) DYNAMIC FIELD OF VIEW SELECTION IN VIDEO

(71) Applicant: Lenovo (Singapore) PTE. LTD., New Tech Park (SG)

(72) Inventors: Scott Li, Cary, NC (US); Russell S. VanBlon, Raleigh, NC (US); Robert J. Kapinos, Durham, NC (US); Robert James Norton, JR., Raleigh, NC (US)

(21) Appl. No.: 17/369,270

(22) Filed: Jul. 7, 2021

(51) Int. Cl. H04N 5/232; G06K 9/00

(52) U.S. Cl. CPC H04N 5/23238; G06K 9/00268; G06K 9/00604; G06K 9/00228; H04N 5/232127

(57) ABSTRACT

Apparatuses, methods, systems, and program products are disclosed for dynamic field of view selection in video. An apparatus includes a processor and memory that stores code executable by the processor to capture a 360-degree video using a 360-degree camera system, detect a direction that a user is looking within the 360-degree video captured using the 360-degree camera system, and set a field of view for the 360-degree video based on the detected direction that the user is looking.

### FIELD

The subject matter disclosed herein relates to digital video and more particularly relates to dynamic field of view selection in 360-degree video.

### BACKGROUND

Video editing can be a time-consuming and tedious process. With the advent of 360-degree video, which provides an immersive experience where “action” or key moments could happen anywhere within the 360-degree arc, the video editing process has become even more time-consuming and labor intensive. The typical 360-degree video workflow is to “steer” the field of view to where the “action” is and then mark video so that particular action field of view is marked to be exported in “rectangular” view. This actions needs to be performed for the entirety of the 360-degree video.

### BRIEF SUMMARY

Apparatuses, methods, systems, and program products are disclosed for dynamic field of view selection in video. In one embodiment, an apparatus includes a processor and memory that stores code executable by the processor to capture a 360-degree video using a 360-degree camera system, detect a direction that a user is looking within the 360-degree video captured using the 360-degree camera system, and set a field of view for the 360-degree video based on the detected direction that the user is looking. In certain embodiments, the field of view includes an orientation within the 360-degree video that is in focus.

In one embodiment, a method includes capturing, by a processor, a 360-degree video using a 360-degree camera system, detecting a direction that a user is looking within the 360-degree video captured using the 360-degree camera system, and setting a field of view for the 360-degree video based on the detected direction that the user is looking. In certain embodiments, the field of view includes an orientation within the 360-degree video that is in focus.

In one embodiment, a program product includes a computer readable storage medium that stores code executable by a processor. In one embodiment, the executable code includes code to capture a 360-degree video using a 360-degree camera system, detect a direction that a user is looking within the 360-degree video captured using the 360-degree camera system, and set a field of view for the 360-degree video based on the detected direction that the user is looking. In certain embodiments, the field of view includes an orientation within the 360-degree video that is in focus.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for dynamic field of view selection in video;

FIG. 2 is a schematic block diagram illustrating one embodiment of an apparatus for dynamic field of view selection in video;

FIG. 3A depicts an example embodiment of dynamic field of view selection in video;

FIG. 3B is a continuation of FIG. 3A;

FIG. 4 is a schematic flow chart diagram illustrating one embodiment of a method for dynamic field of view selection in video; and

FIG. 5 is a schematic flow chart diagram illustrating one embodiment of another method for dynamic field of view selection in video.

### DETAILED DESCRIPTION

As will be appreciated by one skilled in the art, aspects of the embodiments may be embodied as a system, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to emphasize their implementation independence more particularly. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The embodiments may transmit data between electronic devices. The embodiments may further convert the data from a first format to a second format, including converting the data from a non-standard format to a standard format and/or converting the data from the standard format to a non-standard format. The embodiments may modify, update, and/or process the data. The embodiments may store the received, converted, modified, updated, and/or processed data. The embodiments may provide remote access to the data including the updated data. The embodiments may make the data and/or updated data available in real time. The embodiments may generate and transmit a message based on the data and/or updated data in real time. The embodiments may securely communicate encrypted data. The embodiments may organize data for efficient validation. In addition, the embodiments may validate the data in response to an action and/or a lack of an action.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Apparatuses, methods, systems, and program products are disclosed for dynamic field of view selection in video. In one embodiment, an apparatus includes a processor and memory that stores code executable by the processor to capture a 360-degree video using a 360-degree camera system, detect a direction that a user is looking within the 360-degree video captured using the 360-degree camera system, and set a field of view for the 360-degree video based on the detected direction that the user is looking. In certain embodiments, the field of view includes an orientation within the 360-degree video that is in focus.

In one embodiment, the code is further executable by the processor to add field of view information to metadata for the captured 360-degree video. In various embodiments, the field of view information comprises information describing the orientation of the 360-degree video that is in focus and a time frame of the 360-degree video when the described orientation is in focus. In certain embodiments, the orientation information comprises at least one of a direction, an elevation angle, and an arc angle relative to the camera.

In one embodiment, the code is further executable by the processor to automatically process the 360-degree video using the field of view information in the metadata for the 360-degree video. In certain embodiments, the field of view for the 360-degree video is set in real-time while the 360-degree video is being captured. In various embodiments, the field of view for the 360-degree video is set during post-processing of the 360-degree video after the 360-degree video has been captured.

In some embodiments, the detected direction that the user is looking is determined based on an angle of the user's face relative to at least one camera of the 360-degree camera system. In further embodiments, the detected direction that the user is looking is further determined based on at least one of facial feature detection and eye tracking of the user's face.

In one embodiment, the detected direction that the user is looking is determined based on orientation data from at least one sensor proximate to the user's face that captures orientation information. In certain embodiments, the code is further executable by the processor to detect a plurality of faces within the 360-degree video and set the field of view for the 360-degree video based on which of the plurality of faces is closest to at least one camera within the 360-degree video.

In one embodiment, a method includes capturing, by a processor, a 360-degree video using a 360-degree camera system, detecting a direction that a user is looking within the 360-degree video captured using the 360-degree camera system, and setting a field of view for the 360-degree video based on the detected direction that the user is looking. In certain embodiments, the field of view includes an orientation within the 360-degree video that is in focus.

In one embodiment, the method includes adding field of view information to metadata for the captured 360-degree video. In certain embodiments, the field of view information comprises information describing the orientation of the 360-degree video that is in focus and a time frame of the 360-degree video when the described orientation is in focus. In various embodiments, the orientation information comprises at least one of a direction, an elevation angle, and an arc angle relative to the camera.

In one embodiment, the method includes automatically processing the 360-degree video using the field of view information in the metadata for the 360-degree video. In certain embodiments, the field of view for the 360-degree video is set in real-time while the 360-degree video is being captured.

In one embodiment, the field of view for the 360-degree video is set during post-processing of the 360-degree video after the 360-degree video has been captured. In some embodiments, the detected direction that the user is looking is determined based on an angle of the user's face relative to at least one camera of the 360-degree camera system.

In one embodiment, a program product includes a computer readable storage medium that stores code executable by a processor. In one embodiment, the executable code includes code to capture a 360-degree video using a 360-degree camera system, detect a direction that a user is looking within the 360-degree video captured using the 360-degree camera system, and set a field of view for the 360-degree video based on the detected direction that the user is looking. In certain embodiments, the field of view includes an orientation within the 360-degree video that is in focus.

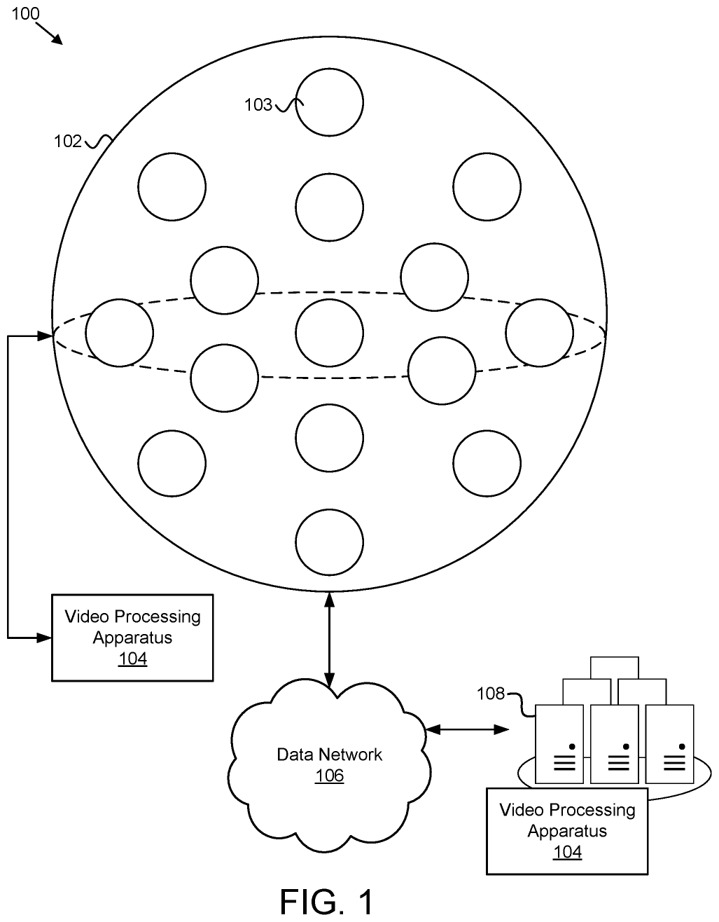

FIG. 1 depicts one embodiment of a system 100 for dynamic field of view selection in video. In one embodiment, the system 100 includes a 360-degree camera system 102, that includes a plurality of cameras 103 that together create an omnidirectional camera. As used herein, omnidirectional cameras have a field of view that covers approximately the entire sphere, or at least a full circle in a horizontal plane. The cameras 103 may be located at various locations around the 360-degree camera system 102. The 360-degree camera system 102 may be configured to capture video using the plurality of cameras 103 and combine each of the videos into a 360-degree video.

As used herein, 360-degree video, also known as immersive videos or spherical videos, are video recordings where a view in every direction is recorded at the same time, shot using an omnidirectional camera or a collection of cameras. During playback on normal flat, rectangular, display the viewer has control of the viewing direction like a panorama. It can also be played on a displays or projectors arranged in a sphere or some part of a sphere.

In one embodiment, the cameras may include digital cameras, lidar cameras, infrared cameras, night-vision cameras, and/or the like. The 360-degree camera system 102 may also include other sensors for capturing environmental data such as location sensors for capturing location data, weather sensors, motion sensors, light sensors, and/or the like. The 360-degree camera system 102 may include computing hardware and software (such as a processor, memory, storage, network interfaces, or the like) for storing and processing videos captured with the cameras 103, for storing and managing metadata associated with the videos (which may include the captured sensor data and other information associated with the videos, described below), and/or the like.

In one embodiment, the system 100 includes a video processing apparatus 104. In general, the video processing apparatus 104 is configured to dynamically determine a field of view of interest within a 360-degree video based on where a user, e.g., the person holding the 360-degree camera system, is looking. In one embodiment, the video processing apparatus 104 captures a 360-degree video using the 360-degree camera system 100, detects a direction that a user is looking within the 360-degree video captured using the 360-degree camera system 100, and sets a field of view for the 360-degree video based on the detected direction that the user is looking.

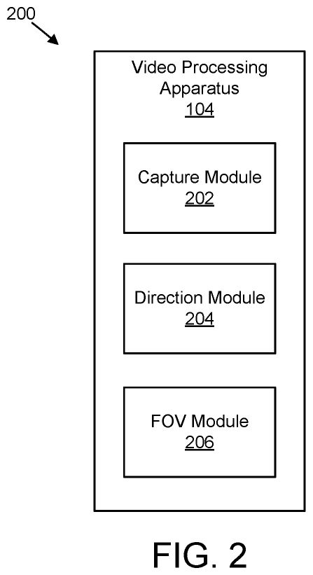

Unlike conventional methods of determining the field of view of interest for a 360-degree video, the video processing apparatus 104 does not require time-intensive post-processing or post-editing to set the field of view for each frame of the 360-degree video, for a time-frame or time-range of the 360-degree video, and/or the like. Instead, the video processing apparatus 104 dynamically marks, flags, sets, or the like a field of view of interest for each frame, for a time-frame or time range, or the like, in real-time, while the 360-degree video is being captured, automatically during post-processing without user input, and/or the like. The video processing apparatus 104 is described in more detail below with reference to FIG. 2.

In certain embodiments, the video processing apparatus 104 may include a hardware device such as a secure hardware dongle or other hardware appliance device (e.g., a set-top box, a network appliance, or the like) that attaches to a device such as the 360-degree camera system 100, a head mounted display, a laptop computer, a server 108, a tablet computer, a smart phone, a security system, a network router or switch, or the like, either by a wired connection (e.g., a universal serial bus (“USB”) connection) or a wireless connection (e.g., Bluetooth®, Wi-Fi, near-field communication (“NEC”), or the like); that attaches to an electronic display device (e.g., a television or monitor using an HDMI port, a DisplayPort port, a Mini DisplayPort port, VGA port, DVI port, or the like); and/or the like. A hardware appliance of the video processing apparatus 104 may include a power interface, a wired and/or wireless network interface, a graphical interface that attaches to a display, and/or a semiconductor integrated circuit device as described below, configured to perform the functions described herein with regard to the video processing apparatus 104.

The video processing apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the video processing apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the video processing apparatus 104.

The semiconductor integrated circuit device or other hardware appliance of the video processing apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the video processing apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”) (e.g., a home network), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like.

At least a portion of the video processing apparatus 104, in one embodiment, is located on the 360-degree camera system 100 and/or on a server 108 that is accessible to the 360-degree camera system 102 via the data network 106. In such an embodiment, the servers 108 may be configured to process video, edit 360-degree video, export a 360-degree video in “rectangular” view, and/or the like.

FIG. 2 depicts one embodiment of an apparatus 200 for dynamic field of view selection in video. In one embodiment, the apparatus 200 includes an instance of a video processing apparatus 104. The video processing apparatus 104, in one embodiments, includes at least one of a capture module 202, a direction module 204, and a FOV module 206, which are described in more detail below.

The capture module 202, in one embodiment, is configured to capture a 360-degree video using a 360-degree camera system, such as the 360-degree camera system 102 described above with reference to FIG. 1, in response to a user command, a signal from a mobile application, actuation of a physical button on the 360-degree camera system 102, and/or the like. The capture module 202, for instance, may capture video or images simultaneously from each of a plurality of cameras of the 360-degree camera system to create an omnidirectional video that can be viewed, interacted with, or the like in 360 degrees.

In various embodiments, the 360-degree video includes a field of view that comprises an area of the 360-degree video that is in focus, especially within a rectangular or other version of the 360-degree video that is viewed on a device such as a smart phone, a tablet computer, a computer with a monitor, and/or the like. When the 360-degree video is viewed using a device with a fully-immersive display experience, e.g., a head mounted display or other virtual reality-type system, the field of view of interest within the 360-degree video may be moved or placed within the field of view of the user, even as it changes. The subject matter disclosed herein dynamically determines and flags, sets, marks, or the like the field of view of interest within the 360-degree video based on the direction that a user is looking so that the field of view of interest does not have to be manually determined and set during post-processing or editing.

The direction module 204, in one embodiment, is configured to detect a direction that a user is looking within the 360-degree video captured using the 360-degree camera system. In one embodiment, the user is the person who is using the 360-degree camera system, e.g., holding a 360-degree camera system mounted on a handle, tripod, selfie-stick, helmet, or held in the user's hand, or the like.

In certain embodiments, the user of the 360-degree camera system may be the nearest user to one or more of the cameras of the 360-degree camera system (because the user is holding the 360-degree camera system or the 360-degree camera system is mounted on a handle that the user is holding, a helmet that the user is wearing, or the like such that the user may be located beneath or proximate to one or more cameras of the 360-degree camera system.

In such an embodiment, the direction module 204 detects, determines, identifies, or the like the direction that the user is looking based on an angle of the user's face relative to at least one camera of the 360-degree camera system. In such an embodiment, the direction module 204 may process one or more images or videos that the cameras of the 360-degree camera system captures and processes the images or videos using image processing, facial feature recognition, or the like to determine the direction that the user's face is pointing relative to the 360-degree camera system, e.g., to identify facial or head features such as eyes, nose, mouth, ears, or the like and determine which direction the features are facing relative to the 360-degree camera system. The determined direction may be used to set the field of view of interest for the 360-degree video, as described below, based on storing data describing the determined direction in metadata for the 360-degree video.

In further embodiments, the direction module 204 detects, determines, identifies, or the like the direction that the user is looking based on eye tracking information. For instance, the direction module 204 may process one or more images or videos that the cameras of the 360-degree camera system captures and processes the images or videos using image processing, facial feature recognition, eye tracking algorithms, or the like to identify the user's eyes and determine which direction the user's eyes are looking relative to the 360-degree camera system.

In one embodiment, the direction module 204 uses one or more sensors on the 360-degree camera system to further determine a direction that the user is looking relative to the 360-degree camera system. The sensors, for instance, may include sensors that capture data that describes orientation information or position information. Such sensors may include accelerometers, geomagnetic field sensors, motion sensors, location sensors, proximity sensors, and/or the like. Data from one or more of these sensors may be used to determine a direction that the 360-degree camera system is moving, the proximity/position of the 360-degree camera system relative to the user, and/or the like, which may be used to derive a direction that the user is looking relative to the 360-degree camera.

The FOV module 206, in one embodiment, is configured to set a field of view for the 360-degree video based on the detected direction that the user is looking. In one embodiment, the field of view includes an orientation within the 360-degree video that is in focus, that is of interest, or the like that is in a direction that the user is looking. The field of view may be used to set the portion of the 360-degree video that is in focus when the 360-degree video is viewed in a rectangular format. The orientation information may include data setting a center of a designated field of view area, e.g., a rectangular area of an arc or segment of a spherical 360-degree video.

In one embodiment, the FOV module 206 is configured to add field of view information to metadata for the captured 360-degree video. The field of view information may include data describing an orientation or position of a segment or arc of a sphere that is the field of view of interest, e.g., a horizontal position, a vertical position, a coordinate (e.g., a three dimensional coordinate designating the center point of the field of view), a direction, an elevation angle, an arc angle relative to the camera, and/or other orientation information describing the field of view within the 360-degree video for focus within a rectangular version of the 360-degree video.

In one embodiment, the field of view information is for a frame of the 360-degree video, for multiple frames of the 360-degree video (e.g., if the field of view does not change within a threshold between frames), for a time frame of the 360-degree video, and/or the like. The metadata, for instance, may include a data packet, data structure, or the like that includes a field for the field of view information described above for each frame of the 360-degree video, for a plurality of frames of the 360-degree video, and/or the like.

In one embodiment, the FOV module 206 is configured to automatically process the 360-degree video using the field of view information in the metadata for the 360-degree video. In such an embodiment, the FOV module 206 may process the 360-degree video in real-time, e.g., while the video is being captured, to set, mark, flag, or the like the field of view of interest for each frame of the 360-degree video. In certain embodiments, the FOV module 206 processes the 360-degree video to set and identify the field of view of interest after the 360-degree video is captured, e.g., during post-processing or editing on a server 108 or other computing device that may have more processing power that the 360-degree camera system.

In one embodiment, the direction module 204 may detect a plurality of faces within the 360-degree video that the capture module 202 captures using the cameras of the 360-degree camera system. In such an embodiment, the FOV module 206 may set the field of view for the 360-degree video based on which of the plurality of faces is closest to at least one camera within the 360-degree video. Typically, this is likely the user who is using the 360-degree camera system. However, depending on the position or location of the 360-degree camera system, the direction module 204 may detect a face that is closer than the user's face, which the FOV module 206 may use to determine or identify the field of view of interest for the 360-degree video.

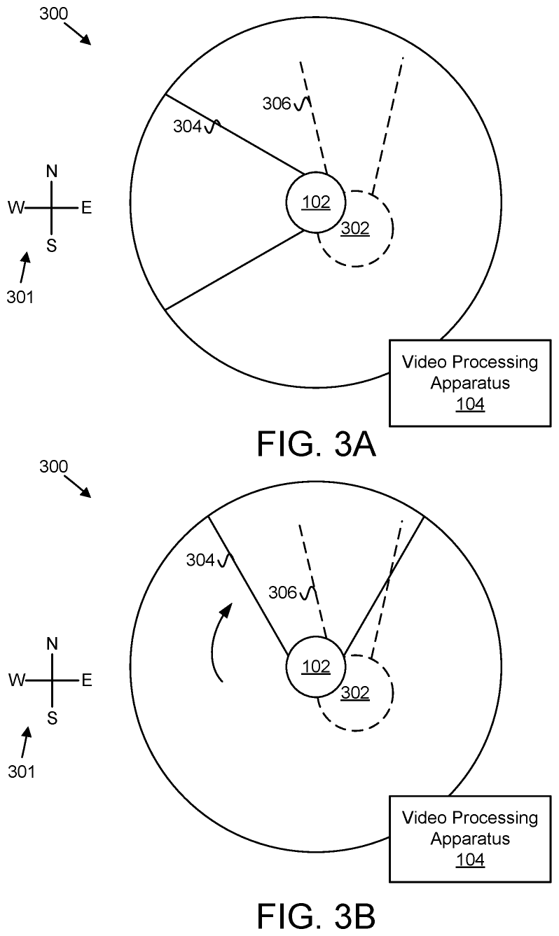

FIG. 3A depicts one example embodiment 300 of dynamic field of view selection in video. In one embodiment, the 360-degree video that the 360-degree camera system captures may have a field of view 304 set, e.g., for a rectangular version of the 360-degree video, in a western direction (see legend 301). The user 302, however, who may be holding or may have the 360-degree camera system mounted to them, may be looking in a northern direction 306.

As shown in FIG. 3B, the video processing apparatus 104, while it is capturing video with the 360-degree camera system 102, may detect the direction that the user 302 is looking, based on facial recognition, eye tracking, and//or the like. In response to detecting that the user 302 is looking in a different direction than the current field of view of the 360-degree video, the video processing apparatus 104 may set, mark, flag, or the like the field of view 304 of interest for the 360-degree video to be in the northern direction to correspond to the user's field of view 306.

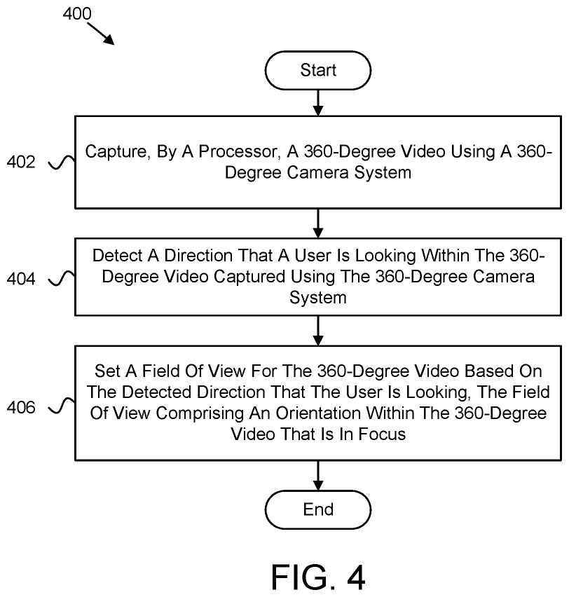

FIG. 4 depicts a schematic flow chart diagram illustrating one embodiment of a method 400 for dynamic field of view selection in video. In one embodiment, the method 400 begins and captures 402, by a processor, a 360-degree video using a 360-degree camera system. In further embodiments, the method 400 detects 404 a direction that a user is looking within the 360-degree video captured using the 360-degree camera system. In certain embodiments, the method 400 sets 406 a field of view for the 360-degree video based on the detected direction that the user is looking, and the method 500 ends. The field of view may include an orientation within the 360-degree video that is in focus. In one embodiment, the capture module 202, the direction module 204, and the FOV module 206 perform the various steps of the method 400.

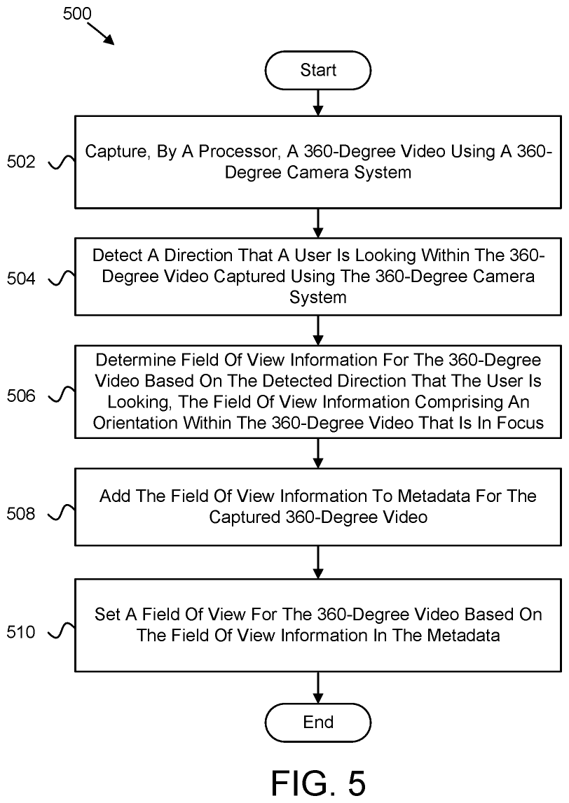

FIG. 5 depicts a schematic flow chart diagram illustrating one embodiment of a method 500 for dynamic field of view selection in video. In one embodiment, the method 500 begins and captures 502, by a processor, a 360-degree video using a 360-degree camera system. In further embodiments, the method 500 detects 504 a direction that a user is looking within the 360-degree video captured using the 360-degree camera system. In certain embodiments, the method 500 determines 506 field of view information for the 360-degree video based on the detected direction that the user is looking. The field of view information may include an orientation within the 360-degree video that is in focus.

In further embodiments, the method 500 adds 508 the field of view information to metadata for the captured 360-degree video. In certain embodiments, the method 500 sets 510 the field of view for the 360-degree video based on the field of view information, either in real-time while the 360-degree video is being captured or in post-processing/editing, and/or a combination of both, and the method 500 ends. In one embodiment, the capture module 202, the direction module 204, and the FOV module 206 perform the various steps of the method 500.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a processor;
a memory that stores code executable by the processor to:
capture a 360-degree video using a 360-degree camera system;
detect a direction that a user is looking within the 360-degree video captured using the 360-degree camera system; and
set a field of view for the 360-degree video based on the detected direction that the user is looking, the field of view comprising an orientation within the 360-degree video that is in focus when the 360-degree video is viewed in a rectangular format.

2. The apparatus of claim 1, wherein the code is further executable by the processor to add field of view information to metadata for the captured 360-degree video.

3. The apparatus of claim 2, wherein the field of view information comprises information describing the orientation of the 360-degree video that is in focus and a time frame of the 360-degree video when the described orientation is in focus.

4. The apparatus of claim 3, wherein the orientation information comprises at least one of a direction, an elevation angle, and an arc angle relative to a camera of the 360-degree camera system.

5. The apparatus of claim 2, wherein the code is further executable by the processor to automatically process the 360-degree video using the field of view information in the metadata for the 360-degree video.

6. The apparatus of claim 1, wherein the field of view for the 360-degree video is set in real-time while the 360-degree video is being captured.

7. The apparatus of claim 1, wherein the field of view for the 360-degree video is set during post-processing of the 360-degree video after the 360-degree video has been captured.

8. The apparatus of claim 1, wherein the detected direction that the user is looking is determined based on an angle of the user's face relative to at least one camera of the 360-degree camera system.

9. The apparatus of claim 8, wherein the detected direction that the user is looking is further determined based on at least one of facial feature detection and eye tracking of the user's face.

10. The apparatus of claim 1, wherein the detected direction that the user is looking is determined based on orientation data from at least one sensor proximate to the user's face that captures orientation information.

11. The apparatus of claim 1, wherein the code is further executable by the processor to:
detect a plurality of faces within the 360-degree video; and
set the field of view for the 360-degree video based on which of the plurality of faces is closest to at least one camera within the 360-degree video.

12. A method comprising:
capturing, by a processor, a 360-degree video using a 360-degree camera system;
detecting a direction that a user is looking within the 360-degree video captured using the 360-degree camera system; and
setting a field of view for the 360-degree video based on the detected direction that the user is looking, the field of view comprising an orientation within the 360-degree video that is in focus when the 360-degree video is viewed in a rectangular format.

13. The method of claim 12, further comprising adding field of view information to metadata for the captured 360-degree video.

14. The method of claim 13, wherein the field of view information comprises information describing the orientation of the 360-degree video that is in focus and a time frame of the 360-degree video when the described orientation is in focus.

15. The method of claim 14, wherein the orientation information comprises at least one of a direction, an elevation angle, and an arc angle relative to a camera.

16. The method of claim 13, further comprising automatically processing the 360-degree video using the field of view information in the metadata for the 360-degree video.

17. The method of claim 12, wherein the field of view for the 360-degree video is set in real-time while the 360-degree video is being captured.

18. The method of claim 12, wherein the field of view for the 360-degree video is set during post-processing of the 360-degree video after the 360-degree video has been captured.

19. The method of claim 12, wherein the detected direction that the user is looking is determined based on an angle of the user's face relative to at least one camera of the 360-degree camera system.

20. A program product comprising a computer readable storage medium that stores code executable by a processor, the executable code comprising code to:
capture a 360-degree video using a 360-degree camera system;
detect a direction that a user is looking within the 360-degree video captured using the 360-degree camera system; and
set a field of view for the 360-degree video based on the detected direction that the user is looking, the field of view comprising an orientation within the 360-degree video that is in focus when the 360-degree video is viewed in a rectangular format.
